(19) United States
(12) Patent Application Publication
(10) Pub. No.: US 2009/0283195 A1
(43) Pub. Date: Nov. 19, 2009

(54) REINFORCEMENT LAYER OF HYBRID CORDS FOR ELASTOMERIC PRODUCTS, PARTICULARLY FOR THE BELT BANDAGE OF PENUMATIC VEHICLE TIRES

(75) Inventors: Wolfgang Reese, Peine (DE); Claus Van Barneveld, Garbsen (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 12/509,516

(22) Filed: Jul. 27, 2009

Related U.S. Application Data
(63) Continuation of application No. PCT/EP2008/050058, filed on Jan. 4, 2008.

(30) Foreign Application Priority Data
Feb. 2, 2007 (DE) 10 2007 005 281.4

(51) Int. Cl. B60C 9/00

(52) U.S. Cl. 152/527

(57) ABSTRACT

A reinforcement layer for elastomeric products, in particular for the belt bandage of pneumatic vehicle tires, are hybrid cords which are arranged generally parallel to one another inside the layer and are composed of a first twisted textile yarn made of a first material and a second twisted textile yarn made of a second material. The ends of both yarns are twisted with each other and the first twisted textile yarn is a polyketone yarn. The reinforcement layer of hybrid cords for elastomeric products, in particular for the belt bandage of pneumatic vehicle tires, has a force-extension behavior that, when using the reinforcement layer as a belt bandage in pneumatic vehicle tires, ensures the simple production of tires, including vulcanization, and a great suitability to high speeds. To this end, the second twisted textile yarn is an aramid yarn.

### CROSS-REFERENCE TO RELATED APPLICATION

This is a continuing application, under 35 U.S.C. § 120, of copending international application No. PCT/EP2008/050058, filed Jan. 4, 2008, which designated the United States; this application also claims the priority, under 35 U.S.C. § 119, of German patent application No. DE 10 2007 005 281.4, filed Feb. 2, 2007; the prior applications are herewith incorporated by reference in their entirety.

### BACKGROUND OF THE INVENTION

### Field of the Invention

The invention relates to a strength element ply for elastomeric articles of manufacture, particularly for a belt bandage of pneumatic vehicle tires. The strength elements are hybrid cords which form an essentially parallel arrangement within the ply and are constructed of a first twisted textile yarn of a first material and of a second twisted textile yarn of a second material which are end-twisted together, wherein the first twisted textile yarn is a polyketone yarn. The invention further relates to a pneumatic vehicle tire containing a belt bandage and/or a bead reinforcer composed of such a strength element ply.

In order that pneumatic vehicle tires, especially pneumatic vehicle tires in high-speed use, may not undergo rise due to the centrifugal forces arising in operation, it is known to provide a pneumatic vehicle tire, which generally includes an air-impermeable inner layer, a radial carcase which contains strength elements and extends from a zenith region of the tire via the side walls into the bead region and there is usually anchored by wrapping around pull-resistant bead cores, a radially external rubber tread strip which has profile grooves, and a belt between the rubber tread strip and the carcase, with a belt bandage. The belt bandage can have a single-ply or multi-ply construction, covers at least the belt edges and contains strength elements, which extend in a parallel manner and essentially in the circumferential direction, in the form of cords embedded in rubber.

In the course of tire production, the bandage is applied in the form of plies with strength elements embedded in an unvulcanized rubber mixture which are wound onto the belt. The strength elements for such plies are embedded in rubber by a sheet of essentially parallel thread-shaped strength elements, which are generally pretreated thermally and/or with impregnation for better adherence to the embedding rubber in a manner known to one skilled in the art, passing in the longitudinal direction through a calender or an extruder for sheathing with the rubber mixture. In the course of shaping with existing apparatus and the vulcanization of the tire, the tire generally expands in the shoulder region, due to the rise by up to 2% and in the center region by up to 4% compared with the unvulcanized green tire when the green tire is wound on a flat drum. With more recent building drums, elongation during tire production is required to be still lower at about not more than 2%. The rise is lower with more recent apparatus.

The cords of the bandage shall allow a sufficient rise in shaping and in the vulcanization mold during tire production in order that the tire may be precisely formed, and they shall ensure, after the tire is finished, good high-speed utility in operation. To meet these requirements, the cords should be extendable with moderate force up to a strain of about 4% and require a very much higher force to be extendable to a higher strain.

A strength element ply of the type in question is known from published, Japanese patent application JP 2005-205933 A, in particular as a reinforcing ply for pneumatic vehicle tires in radial construction as a belt bandage. However, the second twisted textile yarn is a nylon yarn. The reinforcing ply, containing the aforementioned strength elements, is said to have the particular purpose of reducing rolling resistance and tire noise, but also of ensuring tire durability.

### SUMMARY OF THE INVENTION

It is accordingly an object of the invention to provide a reinforcement layer of hybrid cords for elastomeric products, particularly for the belt bandage of pneumatic vehicle tires that overcomes the above-mentioned disadvantages of the prior art devices of this general type.

With the foregoing and other objects in view there is provided, in accordance with the invention, a strength element ply for elastomeric articles of manufacture, in particular for a belt bandage of pneumatic vehicle tires. The strength element ply contains strength elements being hybrid cords forming a generally parallel configuration within the strength element ply and are constructed of a first twisted textile yarn of a first material and of a second twisted textile yarn of a second material which are end-twisted together. The first twisted textile yarn is a polyketone yarn and the second twisted textile yarn is an aramid yarn.

The present invention has for its object to provide a strength element ply of hybrid cords for elastomeric articles of manufacture, particularly for the belt bandage of pneumatic vehicle tires, that has stress-strain characteristics which in use of the strength element ply particularly as a belt bandage in pneumatic vehicle tires permit trouble-free tire building including vulcanization, and endow the tire with good high-speed utility.

We have found that the object is achieved when the second twisted textile yarn is an aramid yarn. The invention thus provides an alternative strength element ply, the strength elements of which are hybrid cords which are formed of two textile, mutually twisted-together yarns, one textile yarn being a polyketone yarn and the other textile yarn being an aramid yarn.

It is essential to the invention that, surprisingly, despite the use of aramid as one of the two yarn materials of the hybrid cord, sufficient extensibility is obtainable during the tire-producing step of shaping, so that the green tire is precisely formable. In addition, the tire has good high-speed utility. It is known that aramid yarns and cords have a particularly high modulus of elasticity and display the properties of non-shrinkage and low plastic deformation which are advantageous as strength element ply in the ready-produced tire. During tire building, by contrast, purely aramid strength element plies prove to be disadvantageous, since their extensibility is too low, so that the green tire is only insufficiently formable and as a result only poor tire uniformity is obtained. In addition, aramid material is costly. Therefore, aramid cords as strength elements, particularly in tire applications as belt bandage, have hitherto not been advantageously usable as strength elements which are subject to extension during tire production. The hybrid cord according to the invention, by contrast, has better extensibility than a purely aramid cord. Compared with aramid/nylon-6,6, the hybrid cord according to the invention has lower shrinkage. The hybrid cord is comparatively inexpensive in acquisition, since polyketone is less costly to acquire. Both the yarns of the hybrid cord have load-bearing properties, so that the tire has improved circumferential stiffness, which are responsible for the good high-speed properties. In addition, precise forming during tire production is made possible, as a result of which the tire has good uniformity.

In addition, the extensibility of the cord can be controlled via suitable dip processes known to one skilled in the art.

Other features which are considered as characteristic for the invention are set forth in the appended claims.

Although the invention is described herein as embodied in a reinforcement layer of hybrid cords for elastomeric products, particularly for the belt bandage of pneumatic vehicle tires, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DETAILED DESCRIPTION OF THE INVENTION

In advantageous developments, either the aramid yarn and/or the polyketone yarn have a linear density ≦1680 dtex. This therefore creates a comparatively fine hybrid cord which, owing to its low weight, but also owing to its above-described advantageous properties such as the strength of both the yarns of the hybrid cord, little if any shrinkage on the part of the cord and good attachability of the cord to rubber, enhances tire performance, particularly of an ultrahigh performance (UHP) tire. The difference in linear density between the two yarns should be kept as small as possible in order to obtain a very uniform cord which has good processing properties and which has good retained strength after fatiguing. Advantageously, the two yarns forming the cord have the same linear density.

It is advantageous when the two yarns forming the hybrid cord are end-twisted together at a twisting rate of 380-480 1/m.

“Polyketone” refers to a polyolefin ketone which is a condensation product of ethene and carbon monoxide.

To ensures reliable adherence of textile strength elements to the rubber, it is advantageous to provide the textile hybrid cords with an adhesive impregnation, for example with an RFL dip in a 1-bath or 2-bath operation.

When at least one of the above-described strength element plies is used in a pneumatic vehicle tire, preferably as a belt bandage, the tire will have particularly good high-speed utility and flatspotting is substantially reduced.

When the above-described strength element ply is used as a bead reinforcer in a pneumatic vehicle tire, the advantage is that the hybrid strength elements have a higher modulus than hitherto customarily used nylon strength element plies, that adherence to the rubber is improved, and is likewise a cost advantage.

Illustrative examples and further advantages of the invention are more particularly elucidated in connection with the table which follows.

A polyketone yarn based on a multifil polyolefin ketone yarn having a linear density of 1670 dtex, Z-twisted at 387 T/m first twist, and an aramid yarn having a linear density of 1670 dtex, Z-twisted, were S-twisted at 387 T/m first twist were end-twisted together at 373 T/m to form a hybrid cord (1670×1 polyketone+1670×1 aramid).

A further illustrative hybrid cord used in the strength element ply according to the invention is a polyketone yarn having a linear density of 1670 dtex, Z-twisted at 409 T/m first twist, and an aramid yarn based on with a linear density of 1100 dtex, Z-twisted at 409 T/m first twist, were S-twisted together with an end twist of 409 T/m to form a hybrid cord (1670×1 polyketone+1100×1 aramid).

These cords had in the undipped state the properties shown in the table. It is believed that these properties are changed only insignificantly, if at all, by dipping. Hybrid cords formed from polyketone and nylon are listed for comparison. Alternatively, the yarns can be S-twisted and the cord Z-twisted.

TABLE

| Hybrid cord | | Hybrid cord | | Hybrid cord | | Hybrid cord | |
|---|---|---|---|---|---|---|---|
| polyketone + aramid | | polyketone + aramid | | polyketone + PA66 | | polyketone + PA66 | |
| dtex | dtex | dtex | dtex | dtex | dtex | dtex | dtex |
| 1670 × 1 | 1670 × 1 | 1670 × 1 | 1100 × 1 | 1670 × 1 | 1400 × 1 | 1670 × 1 | 940 × 1 |

| | | | | |
|---|---|---|---|---|
| Breaking | 349.30 | 329.00 | 274.80 | 251.40 |
| Force (N) | | | | |
| ASTM | | | | |
| D 855 | | | | |
| Elongation | 5.98 | 6.01 | 11.33 | 13.58 |
| at break | | | | |
| (%) ASTM | | | | |
| D 855 | | | | |
| Elongation | 1.70 | 1.75 | 4.46 | 5.94 |
| at 45 N | | | | |
| (%) ASTM | | | | |
| D 855 | | | | |
| Shinkage | 1.00 | 1.03 | 6.37 | 7.13 |
| at 180° C. | | | | |
| (%) ASTM | | | | |
| D 855 | | | | |

It is evident that the hybrid cords formed from polyketone and aramid have a relatively large ASTM D 855 breaking force of 349.3 N and 329.00 N, while the comparable hybrid cords from polyketone and nylon have a breaking force of just 274.80 N and 251.40 N. The increased strength for the hybrid cords formed from polyketone and aramid is attributable to the fact that both the cord portions perform load-bearing functions.

ASTM D 855 elongation at break is about 6% in the case of the hybrid cords formed from polyketone and aramid, while it is approximately twice that for the hybrid cords from polyketone and nylon, at 11.33% and 13.58% respectively. ASTM D 855 elongation at 45N for the hybrid cords formed from polyketone and aramid is merely 1.70% and 1.75%, while it is respectively 4.46% and 5.94% for the hybrid cords formed from polyketone and nylon.

ASTM D 855 shrinkage at 180° C. is likewise more advantageous for the hybrid cords formed from polyketone and aramid compared with the hybrid cords formed from polyketone and nylon. While the hybrid cords formed from polyketone and nylon shrink by 6.37% and 7.13%, the hybrid cords formed from polyketone and aramid shrink by merely 1.00% and 1.03% respectively.

Therefore, the hybrid cord formed from polyketone and aramid provides a strength element ply for elastomeric articles of manufacture, in particular for the belt bandage of pneumatic vehicle tires, which via sufficient extensibility permits a tire build-up, particularly with recent building drums, such that the green tire is precisely formable. In addition, the high strength of the hybrid cord strength element plies endows the tire with circumferential stiffness and particularly good high-speed utility.

1. A strength element ply for elastomeric articles of manufacture, including for a belt bandage of pneumatic vehicle tires, the strength element ply comprising:
strength elements being hybrid cords forming a generally parallel configuration within the strength element ply and are constructed of a first twisted textile yarn of a first material and of a second twisted textile yarn of a second material which are end-twisted together, said first twisted textile yarn is a polyketone yarn and said second twisted textile yarn is an aramid yarn.

2. The strength element ply according to claim 1, wherein said aramid yarn has a linear density ≦1680 dtex.

3. The strength element ply according to claim 1, wherein said polyketone yarn has a linear density ≦1680 dtex.

4. The strength element ply according to claim 1, wherein said first and second twisted yarns are end-twisted together at 380-480 1/m to form a hybrid cord.

5. The strength element ply according to claim 1, wherein said hybrid cords have an adhesive impregnation to ensure adherence of textile strength elements to rubber.

6. A pneumatic vehicle tire, comprising:
at least one strength element ply containing strength elements being hybrid cords forming a generally parallel configuration within said strength element ply and being constructed of a first twisted textile yarn of a first material and of a second twisted textile yarn of a second material which are end-twisted together, said first twisted textile yarn is a polyketone yarn and said second twisted textile yarn is an aramid yarn.

7. The pneumatic vehicle tire according to claim 6, wherein said strength element ply is disposed as at least one of a belt bandage and as a bead reinforcer.
